(19) United States
(12) Patent Application Publication
(10) Pub. No.: US 2025/0329757 A1
(43) Pub. Date: Oct. 23, 2025

(54) AIR SUPPLY DEVICE FOR AN AIRCRAFT FUEL CELL DRIVE

(71) Applicant: MTU Aero Engines AG, München (DE)

(72) Inventor: Jan Hägert, Alling (DE)

(73) Assignee: MTU Aero Engines AG, München (DE)

(21) Appl. No.: 18/260,462

(22) PCT Filed: Dec. 16, 2021
(86) PCT No.: PCT/DE2021/101010

§ 371 Date: Jan. 15, 2024

(30) Foreign Application Priority Data
Jan. 7, 2021 (DE) 10 2021 200 088.6

(51) Int. Cl. H01M 8/04119; B64D 27/355; H01M 8/04014

(52) U.S. Cl. CPC H01M 8/04141; H01M 8/04014; H01M 8/04156; B64D 27/355; H01M 2250/20

(57) ABSTRACT

The invention is directed to an air supply device and to a method for supplying at least one fuel cell of an aircraft fuel cell drive with compressed air, wherein the aircraft fuel cell drive has an air supply device comprising a compressor arrangement, wherein ambient air is compressed by means of the compressor arrangement and a first part of the compressed air is supplied to the at least one fuel cell and a second part of the compressed air can be diverted to a cooling device of the at least one fuel cell by means of a bypass device.

### BACKGROUND OF THE INVENTION

The invention relates to an air supply device for an aircraft fuel cell drive, especially an airplane fuel cell drive, having a compressor arrangement for supplying compressed air to at least one fuel cell, as well as a method for supplying compressed air to at least one fuel cell of an aircraft fuel cell drive.

Fuel cells require for their operation, in addition to a fuel, also an oxidizing agent, which in the case of fuel cells of aircraft drives is usually formed by air, which is compressed in order to achieve a high power density. Since the pressure of the ambient air decreases with increasing flight altitude, at higher flight altitudes it is necessary to increase the mass flow of the supplied air in order to supply sufficiently compressed air to a fuel cell for the most part independently of the flight altitude.

Fuel cells generate heat in addition to electricity and this must be drawn away from the fuel cell in order to prevent overheating. During the flight phases, propeller downwash air and/or ram air, for example, is used for this purpose, but such is not available on the ground outside of a flight phase of an aircraft, or at least not in sufficient amount. Accordingly, an additional cooling of the fuel cell is required during the operation of the fuel cell outside of a flight phase of the aircraft in order to adequately dissipate the heat from it.

### SUMMARY OF THE INVENTION

Starting with this premise, one object of the present invention is to propose an aircraft fuel cell drive having improved air supply, as well as a method for supplying compressed air to an aircraft fuel cell drive. This is accomplished according to the present invention. Advantageous embodiments of the invention are discussed in detail below.

To achieve the object, in a first aspect of the invention, an air supply device is proposed for an aircraft fuel cell drive, having a compressor arrangement for supplying compressed air to at least one fuel cell of the aircraft fuel cell drive. The air supply device comprises at least one bypass device, by which one part of the compressed air can be diverted at least for a time to a cooling device of the at least one fuel cell.

A fuel cell of an aircraft fuel cell drive converts fuel and oxidizing agent into electrical energy and a reaction product. An aircraft fuel cell drive usually comprises a plurality of fuel cells, which are arranged, for example, in the form of fuel cell stacks. Such a fuel cell arrangement, which accordingly comprises at least one fuel cell, is termed for simplicity “at least one fuel cell” in the context of the description of the invention. Similar to a conventional turbomachine which is operated with kerosene, an aircraft fuel cell drive requires compressed air as the oxidizing agent in order to achieve a high power density. The air supply device serves for supplying compressed ambient air to the at least one fuel cell and comprises for this purpose the necessary pipelines, connectors, and valves, besides a compressor arrangement. The compressor arrangement comprises at least one appropriately dimensioned compression device, by which the at least one fuel cell of the aircraft fuel cell drive can be supplied with an adequate air mass flow for the power generation, even at great flight altitudes.

A fuel cell of an aircraft fuel cell drive converts fuel and oxidizing agent into electrical energy and a reaction product. An aircraft fuel cell drive usually comprises a plurality of fuel cells, which are arranged, for example, in the form of fuel cell stacks. Such a fuel cell arrangement, which accordingly comprises at least one fuel cell, is termed for simplicity “at least one fuel cell” in the context of the description of the invention. Similar to a conventional turbomachine which is operated with kerosene, an aircraft fuel cell drive requires compressed air as the oxidizing agent in order to achieve a high power density. The air supply device serves for supplying compressed ambient air to the at least one fuel cell and comprises for this purpose the necessary pipelines, connectors, and valves, besides a compressor arrangement. The compressor arrangement comprises at least one appropriately dimensioned compression device, by which the at least one fuel cell of the aircraft fuel cell drive can be supplied with an adequate air mass flow for the power generation, even at great flight altitudes.

A fuel cell of an aircraft fuel cell drive converts fuel and oxidizing agent into electrical energy and a reaction product. An aircraft fuel cell drive usually comprises a plurality of fuel cells, which are arranged, for example, in the form of fuel cell stacks. Such a fuel cell arrangement, which accordingly comprises at least one fuel cell, is termed for simplicity “at least one fuel cell” in the context of the description of the invention. Similar to a conventional turbomachine which is operated with kerosene, an aircraft fuel cell drive requires compressed air as the oxidizing agent in order to achieve a high power density. The air supply device serves for supplying compressed ambient air to the at least one fuel cell and comprises for this purpose the necessary pipelines, connectors, and valves, besides a compressor arrangement. The compressor arrangement comprises at least one appropriately dimensioned compression device, by which the at least one fuel cell of the aircraft fuel cell drive can be supplied with an adequate air mass flow for the power generation, even at great flight altitudes.

Such a compression device for the compressing of ambient air can be designed for example as a radial compressor. A compression device suitable for the compressing of air as the oxidizing agent for fuel cells is usually mounted oil-free, in particular being designed with a pneumatic bearing or a hydrodynamic bearing. For example, a compression device of the compressor arrangement can also be designed in the form of a screw or turbo compressor.

The air supply device comprises at least one bypass device, by which a portion of the compressed air can be diverted at least for a time to a cooling device of the fuel cell. In this way, a portion of the compressed air from the compressor arrangement can be taken to a cooling device, especially in dependence on the operating state of the fuel cell and/or the compressor arrangement, being designed to carry away the excess heat generated by the at least one fuel cell in order to prevent, in particular, an overheating of the at least one fuel cell. The bypass device can be controlled or regulated, for example, so that the portion of the compressed air taken by this to the cooling device can be adjusted. The bypass device takes the diverted air in particular directly to the cooling device of the at least one fuel cell. If there is no cooling demand for the at least one fuel cell, the entire compressor power can be used to supply the fuel cell with oxidizing agent.

The bypass device may have a branching device situated at the compressor arrangement, which is designed in the form of a valve, especially one which can be controlled or regulated, and which is arranged on an air duct for supplying the fuel cell with compression arrangement can be branched off. This is then used not as oxidizing agent for the supplying of the fuel cell—like the other portion of the compressed air—but instead for the cooling of the fuel cell.

By the proposed air supply device, a portion of the compressed air can be diverted to a cooling device of the at least one fuel cell especially in a needs-based manner and therefore in particular for a certain time. In operating phases when the at least one fuel cell has no need for cooling by the cooling device, the bypass can also be closed, so that the entire compressed air from the compression arrangement can be taken to the at least one fuel cell as oxidizing agent. Accordingly, the air mass flow taken by the bypass device to the cooling device of the at least one fuel cell can be supplied in time and/or volume controlled manner, depending on its cooling demand. For example, it is possible for little or no air mass flow to be taken by the bypass device to the cooling device in periods of time with little or no cooling demand, and for a relatively large air mass flow to be taken there in periods of time with a great cooling demand.

One such cooling device can comprise, for example, at least one ejector operated by the compressed air (jet pump/air multiplier), which can be used to support the overall cooling system, in addition to cooling the fuel cell, also serving in particular for the cooling of e-motors and frequency converters. The cooling device may also have air outlet nozzles, which are situated in the area of a fuel cell and convey cooling air in particular over the surface of the fuel cell housing. This housing or the cooling device can also have, in particular, cooling fins which improve the heat dissipation or other suitable elements bathed in the cooling air flow or carrying that flow, such as cooling tubes or cooling ducts, or also suitable fans, air boosters, or the like, to improve the heat dissipation by the cooling air from the at least one fuel cell.

The proposed air supply device enables a branching off of a portion of the installed compressor capacity for the cooling, especially on the ground and at low flight altitudes. Since a higher ambient air pressure prevails near the ground, the corrected air mass flow through the compressor is smaller, given the same quantity delivered to the fuel cell. With phase adequate airflow is available and the fuel cell is operated with less power, at the same time its cooling demand decreases. In this way, the proposed air supply device for an aircraft fuel cell drive makes possible an advantageous interaction of an adequate air mass flow for the supplying of adequate oxidizing agent in the form of compressed air to the at least one fuel cell, even at great flight altitudes, and the providing of an adequately large cooling air flow for the cooling of the at least one fuel cell on the ground and in flight phases with less heat dissipation by the flight wind, such as during the waiting time before the start of take-off. At that time the power of the fuel cell is high, while at the same time little or no cooling air is available from the relative velocity. Such a compression device for the compressing of ambient air can be designed for example as a radial compressor. A compression device suitable for the compressing of air as the oxidizing agent for fuel cells is usually mounted oil-free, in particular being designed with a pneumatic bearing or a hydrodynamic bearing. For example, a compression device of the compressor arrangement can also be designed in the form of a screw or turbo compressor.

The air supply device comprises at least one bypass device, by which a portion of the compressed air can be diverted at least for a time to a cooling device of the fuel cell. In this way, a portion of the compressed air from the compressor arrangement can be taken to a cooling device, especially in dependence on the operating state of the fuel cell and/or the compressor arrangement, being designed to carry away the excess heat generated by the at least one fuel cell in order to prevent, in particular, an overheating of the at least one fuel cell. The bypass device can be controlled or regulated, for example, so that the portion of the compressed air taken by this to the cooling device can be adjusted. The bypass device takes the diverted air in particular directly to the cooling device of the at least one fuel cell. If there is no cooling demand for the at least one fuel cell, the entire compressor power can be used to supply the fuel cell with oxidizing agent.

The bypass device may have a branching device situated at the compressor arrangement, which is designed in the form of a valve, especially one which can be controlled or regulated, and which is arranged on an air duct for supplying the fuel cell with compression arrangement can be branched off. This is then used not as oxidizing agent for the supplying of the fuel cell—like the other portion of the compressed air—but instead for the cooling of the fuel cell.

By the proposed air supply device, a portion of the compressed air can be diverted to a cooling device of the at least one fuel cell especially in a needs-based manner and therefore in particular for a certain time. In operating phases when the at least one fuel cell has no need for cooling by the cooling device, the bypass can also be closed, so that the entire compressed air from the compression arrangement can be taken to the at least one fuel cell as oxidizing agent. Accordingly, the air mass flow taken by the bypass device to the cooling device of the at least one fuel cell can be supplied in time and/or volume controlled manner, depending on its cooling demand. For example, it is possible for little or no air mass flow to be taken by the bypass device to the cooling device in periods of time with little or no cooling demand, and for a relatively large air mass flow to be taken there in periods of time with a great cooling demand.

One such cooling device can comprise, for example, at least one ejector operated by the compressed air (jet pump/air multiplier), which can be used to support the overall cooling system, in addition to cooling the fuel cell, also serving in particular for the cooling of e-motors and frequency converters. The cooling device may also have air outlet nozzles, which are situated in the area of a fuel cell and convey cooling air in particular over the surface of the fuel cell housing. This housing or the cooling device can also have, in particular, cooling fins which improve the heat dissipation or other suitable elements bathed in the cooling air flow or carrying that flow, such as cooling tubes or cooling ducts, or also suitable fans, air boosters, or the like, to improve the heat dissipation by the cooling air from the at least one fuel cell.

The proposed air supply device enables a branching off of a portion of the installed compressor capacity for the cooling, especially on the ground and at low flight altitudes. Since a higher ambient air pressure prevails near the ground, the corrected air mass flow through the compressor is smaller, given the same quantity delivered to the fuel cell. With phase adequate airflow is available and the fuel cell is operated with less power, at the same time its cooling demand decreases. In this way, the proposed air supply device for an aircraft fuel cell drive makes possible an advantageous interaction of an adequate air mass flow for the supplying of adequate oxidizing agent in the form of compressed air to the at least one fuel cell, even at great flight altitudes, and the providing of an adequately large cooling air flow for the cooling of the at least one fuel cell on the ground and in flight phases with less heat dissipation by the flight wind, such as during the waiting time before the start of take-off. At that time the power of the fuel cell is high, while at the same time little or no cooling air is available from the relative velocity. Such a compression device for the compressing of ambient air can be designed for example as a radial compressor. A compression device suitable for the compressing of air as the oxidizing agent for fuel cells is usually mounted oil-free, in particular being designed with a pneumatic bearing or a hydrodynamic bearing. For example, a compression device of the compressor arrangement can also be designed in the form of a screw or turbo compressor.

The air supply device comprises at least one bypass device, by which a portion of the compressed air can be diverted at least for a time to a cooling device of the fuel cell. In this way, a portion of the compressed air from the compressor arrangement can be taken to a cooling device, especially in dependence on the operating state of the fuel cell and/or the compressor arrangement, being designed to carry away the excess heat generated by the at least one fuel cell in order to prevent, in particular, an overheating of the at least one fuel cell. The bypass device can be controlled or regulated, for example, so that the portion of the compressed air taken by this to the cooling device can be adjusted. The bypass device takes the diverted air in particular directly to the cooling device of the at least one fuel cell. If there is no cooling demand for the at least one fuel cell, the entire compressor power can be used to supply the fuel cell with oxidizing agent.

The bypass device may have a branching device situated at the compressor arrangement, which is designed in the form of a valve, especially one which can be controlled or regulated, and which is arranged on an air duct for supplying the fuel cell with compression arrangement can be branched off. This is then used not as oxidizing agent for the supplying of the fuel cell—like the other portion of the compressed air—but instead for the cooling of the fuel cell.

By the proposed air supply device, a portion of the compressed air can be diverted to a cooling device of the at least one fuel cell especially in a needs-based manner and therefore in particular for a certain time. In operating phases when the at least one fuel cell has no need for cooling by the cooling device, the bypass can also be closed, so that the entire compressed air from the compression arrangement can be taken to the at least one fuel cell as oxidizing agent. Accordingly, the air mass flow taken by the bypass device to the cooling device of the at least one fuel cell can be supplied in time and/or volume controlled manner, depending on its cooling demand. For example, it is possible for little or no air mass flow to be taken by the bypass device to the cooling device in periods of time with little or no cooling demand, and for a relatively large air mass flow to be taken there in periods of time with a great cooling demand.

One such cooling device can comprise, for example, at least one ejector operated by the compressed air (jet pump/air multiplier), which can be used to support the overall cooling system, in addition to cooling the fuel cell, also serving in particular for the cooling of e-motors and frequency converters. The cooling device may also have air outlet nozzles, which are situated in the area of a fuel cell and convey cooling air in particular over the surface of the fuel cell housing. This housing or the cooling device can also have, in particular, cooling fins which improve the heat dissipation or other suitable elements bathed in the cooling air flow or carrying that flow, such as cooling tubes or cooling ducts, or also suitable fans, air boosters, or the like, to improve the heat dissipation by the cooling air from the at least one fuel cell.

The proposed air supply device enables a branching off of a portion of the installed compressor capacity for the cooling, especially on the ground and at low flight altitudes. Since a higher ambient air pressure prevails near the ground, the corrected air mass flow through the compressor is smaller, given the same quantity delivered to the fuel cell. With phase adequate airflow is available and the fuel cell is operated with less power, at the same time its cooling demand decreases. In this way, the proposed air supply device for an aircraft fuel cell drive makes possible an advantageous interaction of an adequate air mass flow for the supplying of adequate oxidizing agent in the form of compressed air to the at least one fuel cell, even at great flight altitudes, and the providing of an adequately large cooling air flow for the cooling of the at least one fuel cell on the ground and in flight phases with less heat dissipation by the flight wind, such as during the waiting time before the start of take-off. At that time the power of the fuel cell is high, while at the same time little or no cooling air is available from the relative velocity.

In one embodiment of the air supply device, the compressor arrangement comprises at least two compressor devices. The at least two compressor devices for the compressing of the air can be arranged in parallel or in series, so that the at least two compressor devices form a single or a multiple stage compressor arrangement. The driving of the compressor devices can be from an electric motor, for example, and in particular at least two parallel arranged compressor devices can also be driven by a common electric motor.

In another embodiment of the air supply device, the compressor arrangement has at least two stages. The air in this case is taken from one compressor stage to the next, so that with each compressor stage the degree of compression and thus the pressure or the density of the compressed air increases. Thus, an increasing degree of compression of the air can be achieved with an increasing number of compressor stages. In this configuration as well, each compressor stage comprises one or more parallel arranged compression devices. Advantageously, relatively small compressors with low design height can also be used in such a compressor arrangement.

In one embodiment of the air supply device, the bypass device is situated downstream from the first or downstream from a second or downstream from a further compressor stage. Due to the increasing compression of the air with each compressor stage, the degree of compression of the air supplied to the cooling device of the fuel cell can be established during the design process for the air supply device by the arrangement of the bypass device or the air inlet of the bypass device. In this way, the cooling action of the cooling device can be influenced by the arrangement of the bypass device. In particular, the positioning of the bypass device and thus a branching at the compressor arrangement will determine the portion of the compressed air taken to the at least one fuel cell and the portion taken to the cooling device, and at the same time also influences the degree of compression of the compression arrangement downstream from the bypass device.

One embodiment of the air supply device comprises at least one air cooler for cooling the compressed air. Such an air cooler can be designed for example as a heat exchanger. Due to the compression process, especially due to the internal gas friction arising in this way, the temperature of the air taken through the air supply device rises. Due to the higher temperature of the compressed air, the corrected air mass flow increases, especially also in a following compressor stage, and so too does its power demand. By the at least one air cooler, the air in the air supply device can be cooled, especially after at least one compression stage, so that a larger air mass flow can be supplied to the at least one fuel cell and/or the cooling device of the at least one fuel cell.

One embodiment of the air supply device comprises a water separator situated downstream from the at least one fuel cell for separating water from the exhaust gas of the at least one fuel cell. At least some of the separated water can be used for humidifying the air which is taken as oxidizing agent to the at least one fuel cell. The water here serves for humidifying the polymer electrolyte membrane of the fuel cell, in order to increase its capability. Likewise, the humidifying of the oxidizing agent also lowers the temperature of the air mass flow supplied directly to the fuel cell. In order to operate the at least one fuel cell with advantageous efficiency, it is advantageous for the temperature of the oxidizing agents supplied to the at least one fuel cell to lie in a favorable temperature range. This temperature range is dependent on the type of fuel cell and in the case of low-temperature fuel cells for example it lies between 55° C. and 95° C. In addition, separated water can be used for other devices of the aircraft fuel cell drive or the aircraft, such as cooling devices for example. The separating of water from the exhaust gas of the at least one fuel cell also serves in addition for environmental protection, since this can reduce the formation of condensation trails in the atmosphere.

In one embodiment of the air supply device, it comprises a control device for controlling the devices of the air supply device. Such a control device serves not only for controlling, of course, but also for regulating the air supply device with its elements, and for incorporating the air supply into the control of the aircraft fuel cell drive and the aircraft as a whole. In the context of the invention, the term “control” shall also be used for a corresponding “regulating”. The control device of the air supply device in the context of the present invention serves in particular for coordinating the compression performance of the compressor arrangement with the supply of compressed air for the at least one fuel cell and thus for the adequate supplying of oxidizing agent regardless of the flight altitude and for providing an adequate cooling air flow for the cooling of the at least one fuel cell, especially on the ground or in flight phases with a cooling demand.

In a second aspect, as the solution of the problem, a method is proposed for supplying compressed air to at least one fuel cell of an aircraft fuel cell drive, wherein the aircraft fuel cell drive comprises an a supply device having a compressor arrangement, characterized by the steps:
compressing of ambient air by the compressor arrangement;
supplying at least one part of the compressed air to the at least one fuel cell; and
diverting one part of the compressed air for the cooling of the at least one fuel cell depending on the cooling demand of the at least one fuel cell.

An air supply device for an aircraft fuel cell drive with a compressor arrangement which is suitable for the application of the proposed method can be designed in accordance with the previous specification, or a portion thereof, and it may comprise at least some of the features described for this.

In a first step of the method, a compressing of ambient air is carried out in the compressor arrangement of the air supply device, especially for the supplying of the compressed air as oxidizing agent to the at least one fuel cell. The achieved degree of compression of the compressed air or the generated air mass flow will depend on the ambient conditions of the aircraft fuel cell drive, especially the ambient pressure diminishing with increasing flight altitude. In order to reach an adequate degree of compression, the compressor arrangement can comprise multiple compressor devices and/or compressor stages, as was proposed for example in connection with the air supply device proposed above in the first aspect of the invention.

In a second step of the method, at least part of the compressed air is supplied to the at least one fuel cell, where it serves as oxidizing agent for generating the power of the fuel cell. In order to operate the at least one fuel cell with high efficiency, as already described above for the proposed air supply device, an adequate air mass flow and thus an adequate degree of compression of the supplied air is also required.

In a third step of the method, depending on the cooling demand of the at least one fuel cell, part of the compressed air is diverted for the cooling of the at least one fuel cell. In this way, a portion of the compressed air from the compressor arrangement can be used for cooling the at least one fuel cell, depending on the cooling demand of the at least one fuel cell and especially also on the operating state of the compressor arrangement, especially in order to avoid an overheating of the fuel cell. In phases when the at least one fuel cell has a high demand for oxidizing agent for its operation, yet the cooling demand is low for example on account of a strong flight wind, the diverting of part of the compressed air for the cooling of the at least one fuel cell can also be optionally interrupted, at least for a time.

For the cooling of the at least one fuel cell with part of the compressed air, a cooling device can be provided, arranged especially in the area of the at least one fuel cell, having one or more features of the cooling device previously described in connection with the proposed air supply device.

For the diverting of the compressed air for the cooling of the at least one fuel cell, the air supply device can have at least one in particular controllable bypass device, which is designed according to one or more features of the bypass device described above in connection with the proposed air supply device. The diverted air is thus used not as oxidizing agent for supplying the fuel cell—as is the other portion of the compressed air—but rather for the cooling of the at least one fuel cell.

The proposed method for supplying compressed air to at least one fuel cell of an aircraft fuel cell drive thus makes possible an advantageous interaction of an adequate air mass flow to supply an adequate oxidizing agent amount in the form of compressed air to the at least one fuel cell, even at great flight altitudes, and the providing of an adequately large cooling air flow for the cooling of the at least one fuel cell, especially on the ground or in flight phases with little heat dissipation by the flight wind. In event of less air demand of the at least one fuel cell to generate the performance, for example at low flight altitudes or flight speeds or on the ground, the compressed air not needed to generate the power can be used for cooling the at least one fuel cell.

One embodiment of the method for supplying compressed air to at least one fuel cell of an aircraft fuel cell drive involves as a further step controlling the compression performance of the compressor arrangement especially in dependence on the ambient conditions and/or the operating state of the at least one fuel cell. For example, the temperature of the at least one fuel cell, resulting in a demand for the air mass flow required for the cooling of the at least one fuel cell, can go into the control process for the compression performance.

One embodiment of the method for supplying compressed air to at least one fuel cell of an aircraft fuel cell drive involves as a further step cooling the compressed air. For this purpose, the air supply device comprises at least one air cooler, which can be designed as a heat exchanger, for example. Such an air cooler can be arranged for example downstream from at least one compressor stage, in order to cool down the air heated in particular by the compression process and thus achieve a higher degree of compression. Thus, the cooling of the compressed air contributes to increasing the air mass flow provided by the air supply device.

One embodiment of the method for supplying compressed air to at least one fuel cell of an aircraft fuel cell drive involves as a further step humidifying the compressed air by supplying water. As already described above, the water can decrease in particular the temperature of the air mass flow supplied directly to the fuel cell. A lower temperature of the oxidizing agent improves the efficiency of the at least one fuel cell. In particular, water separated from the exhaust gas of the at least one fuel cell can be used for humidifying the compressed air.

### BRIEF DESCRIPTION OF THE DRAWINGS FIGURES

Further features, benefits, and application possibilities of the invention will emerge from the following description in conjunction with the figures. Herein are shown:

FIG. 1 a schematic representation of an exemplary air supply device according to the invention for an aircraft fuel cell drive;

FIG. 2 a schematic representation of another exemplary air supply device according to the invention for an aircraft fuel cell drive;

FIG. 3 a schematic representation of yet another exemplary air supply device according to the invention for an aircraft fuel cell drive; and

FIG. 4 a schematic representation of a flow chart of the method according to the invention for supplying compressed air to at least one fuel cell of an aircraft fuel cell drive.

### DESCRIPTION OF THE INVENTION

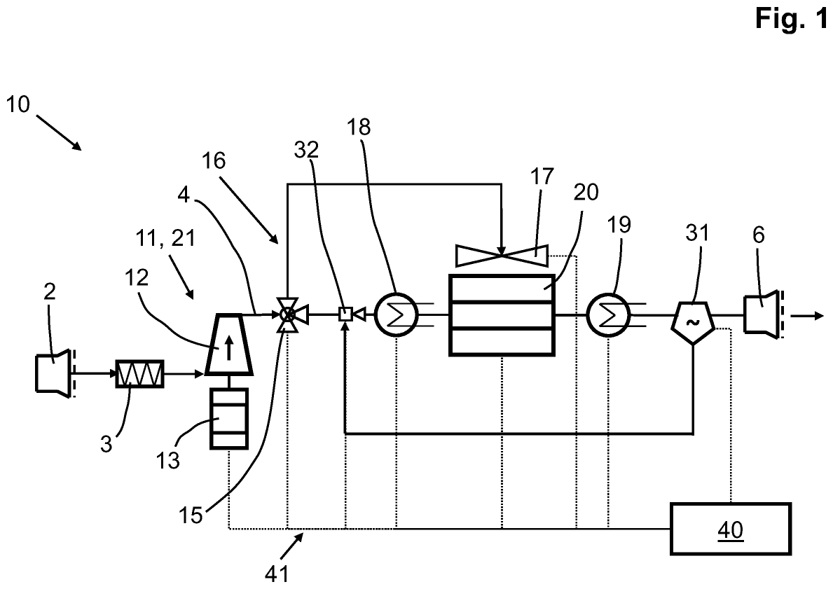

FIG. 1 shows a schematic representation of an exemplary air supply device 10 according to the invention for an aircraft fuel cell drive. The air supply device 10 comprises a compressor arrangement 11 for supplying compressed air to the at least one fuel cell 20. The compressor arrangement 11 comprises a compressor device 12, which is operated by an electric motor 13.

The air supply device 10 is supplied with ambient air through an air inlet 2, which is then taken through an air filter 3 to a compressor device 12 of the compressor arrangement 11. In the compressor device 12, the ambient air is compressed and taken in a supply line 4 to the at least one fuel cell 20.

On the supply line 4 of the air supply device 10 is arranged a bypass device 16, by which a portion of the compressed air can be diverted for at least some of the time to a cooling device 17 of the at least one fuel cell 20. The bypass device 16 comprises a branching device 15 situated downstream from the compressor device 12 and thus downstream from the first and only compressor stage 21, by which some of the compressed air can be diverted from the air flow. By the bypass device 16, the compressed air can be taken to the cooling device 17, serving there for the cooling of the at least one fuel cell 20.

After the compressor arrangement 21 of the air supply device 10 and before the at least one fuel cell 20 there is arranged an air cooler 18, which serves for the cooling of the compressed air. With the aid of the air cooler 18, the efficiency of the at least one fuel cell 20 can be increased, since fuel cells undergoing a flow through them of a cooler air mass flow will have more air and thus more oxidizing agent flowing through them, so that higher power can be generated.

In the exhaust gas flow after the fuel cell 20 there is furthermore arranged an exhaust gas cooler 19 for cooling the exhaust gas coming from the fuel cell 20. This cooling process serves on the one hand for recovering the heat and thus the energy and, furthermore, it reduces the formation of condensation trails during flight operation. In addition, the exhaust gas flow coming from the at least one fuel cell 20 is taken across a water separator 31 arranged in the air flow after the fuel cell 20, which separates water from the exhaust gas of the at least one fuel cell 20. At least a portion of the water separated by the water separator 31 is taken to a humidifier device 32, which thereby humidifies the compressed air flow supplied to the fuel cell 20 and also lowers its temperature in addition. Finally, the spent ambient air is put out to the surroundings via the air outlet 6.

The air supply device 10 furthermore comprises a control device 40 for controlling the devices of the air supply device 10. The devices of the air supply device 10 which are controlled by the control device 40 include for example, in the embodiment shown in FIG. 1, the compressor arrangement 21, the branching device 15, the humidifier device 32, the air cooler 18, the at least one fuel cell 20, the exhaust gas cooler 19 and the water separator 31, being shown connected to the control device 40 by signal lines 41 shown as broken lines.

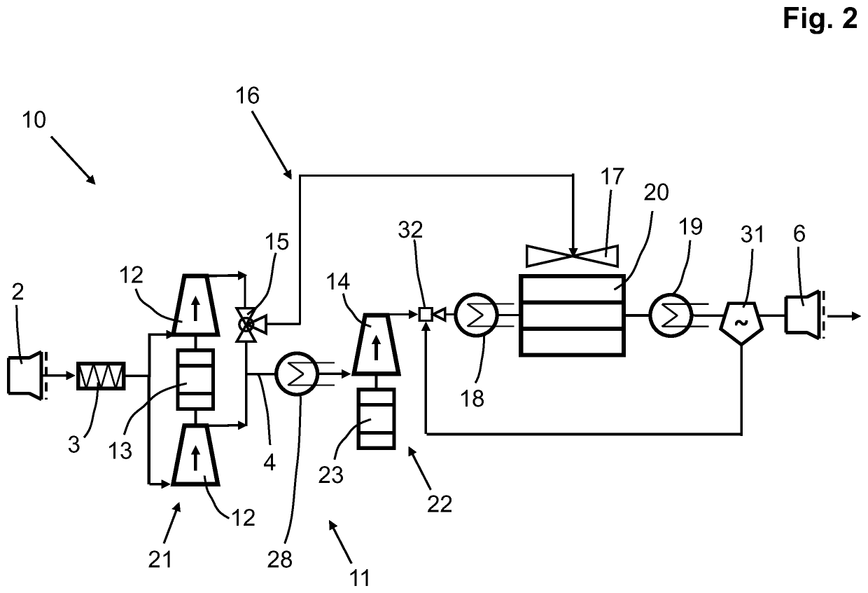

FIG. 2 shows a schematic representation of another exemplary air supply device 10 according to the invention for an aircraft fuel cell drive. The air supply device 10 here comprises a two-stage compressor arrangement 11 for supplying compressed air to the at least one fuel cell 20. The first compressor stage 21 of the compressor arrangement 11 comprises two parallel arranged compressor devices 12, which are powered by an electric motor 13, and the second compressor stage 22 of the compressor arrangement 11 likewise comprises a compressor device 14 powered by an electric motor 23.

As in the embodiment of FIG. 1, ambient air is supplied to the air supply device 10 via an air inlet 2, and it is then taken through an air filter 3 to the first compressor stage 21 of the compressor arrangement 11. The compressor devices 12 compress the ambient air and deliver it in parallel to a supply line 4. In the supply line 4 there is arranged an air cooler 28, which serves for the cooling of the air compressed in the first compressor stage 21. The cooled compressed air is then further compressed by the second compressor stage 22 and taken on to the at least one fuel cell 20.

In the embodiment of the air supply device 10 shown as an example in FIG. 2, the branching device 15 of the bypass device 16 is situated after one of the compressor devices 12 of the first compressor stage 21. Other than this, the layout and function of the bypass device 16 in FIG. 2 corresponds to the layout and function of the bypass device 16 of FIG. 1.

As in the embodiment of the air supply device 10 represented in FIG. 1, there are arranged in the exhaust gas flow after the fuel cell 20 of the air supply device 10 represented in FIG. 2 an exhaust gas cooler 19, a water separator 31 and an air outlet 6. Similar to the embodiment of FIG. 1, at least a portion of the separated water is taken to a humidifier device 32, in order to humidify the compressed air flow supplied to the fuel cell 20.

The air supply device 10 described in connection with FIG. 2 also comprises a control device 40, not shown, for controlling the devices of the air supply device 10.

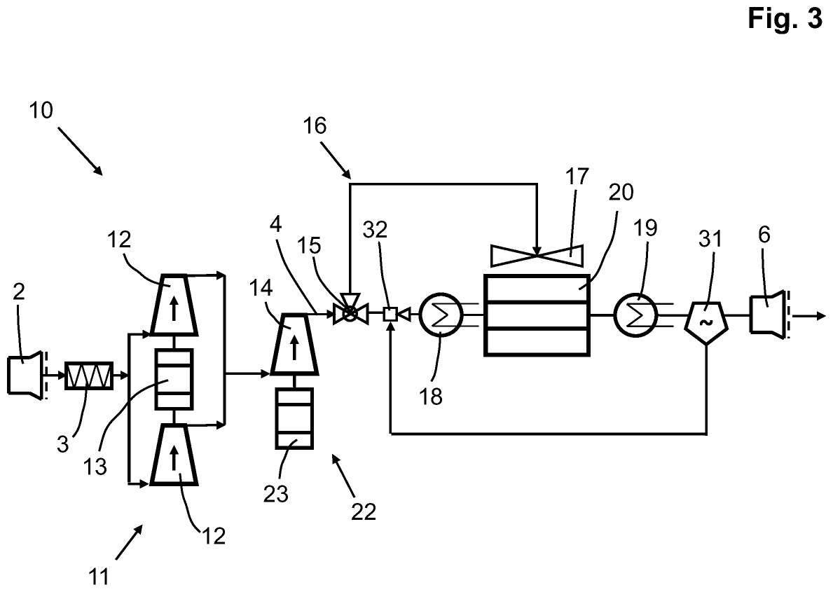

FIG. 3 shows a schematic representation of yet another exemplary air supply device 10 according to the invention for an aircraft fuel cell drive, the layout of which corresponds in large part to the layout of the air supply device 10 represented in FIG. 2. The basic layout of the air supply devices 10 represented in FIGS. 2 and 3 differs basically in the arrangement of the bypass device 16 and in the fact that the air supply device 10 of FIG. 3 has no air cooler 28 for cooling the air compressed in the first compressor stage 21. Accordingly, the differences between the two embodiments will be described in the following.

In the exemplary embodiment of the air supply device 10 represented in FIG. 3, the branching device 15 of the bypass device 16 is situated after the second compressor stage 22 in the supply line 4, so that in this embodiment more heavily compressed air is taken via the bypass device 16 to the cooling device 17, and serving there for the cooling of the at least one fuel cell 20.

The air supply device 10 described in connection with FIG. 3 also comprises a control device 40, not shown, for controlling the devices of the air supply device 10.

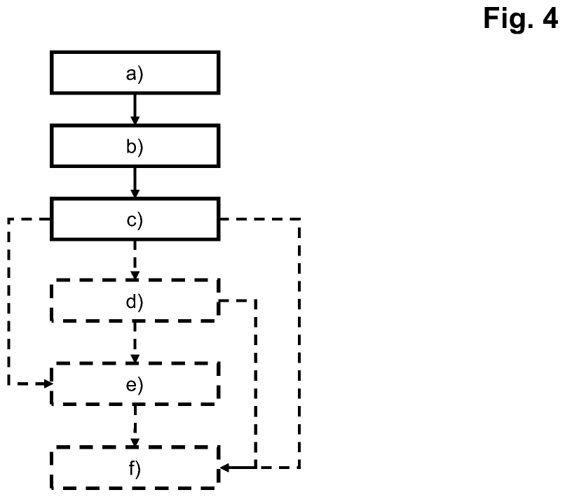

FIG. 4 shows a schematic representation of a flow chart of the method according to the invention for supplying compressed air to at least one fuel cell 20 of an aircraft fuel cell drive, the aircraft fuel cell drive having an air supply device 10 with a compressor arrangement 11.

The method according to the invention involves the following steps: in a first step a), ambient air is compressed by the compressor arrangement 11, and in a second step b) at least a portion of the compressed air is taken to the at least one fuel cell 20. In a further step c), a portion of the compressed air is diverted for cooling of the at least one fuel cell 20, depending on the cooling demand of the at least one fuel cell 20.

In an optional embodiment of the method, in a step d) the compression performance of the compressor arrangement 11 is controlled in particular depending on the ambient conditions and/or the operating state of the at least one fuel cell 20. In a further optional embodiment of the method, in a step e) the compressed air is cooled and in a further optional embodiment of the method in a step f) the compressed air is humidified by the adding of water.

1. An air supply device for an aircraft fuel cell drive having a compressor arrangement for supplying compressed air to the at least one fuel cell wherein at least one bypass device, by which one part of the compressed air is diverted at least for a time to a cooling device of the at least one fuel cell.

2. The air supply device according to claim 1, wherein the compressor arrangement comprises at least two compressor devices.

3. The air supply device according to claim 2, wherein the compressor arrangement has at least two stages.

4. The air supply device according to claim 1, wherein the bypass device is situated downstream from the first or downstream from a second or downstream from a further compressor stage.

5. The air supply device according to claim 1, further comprising at least one air cooler for cooling the compressed air.

6. The air supply device according to claim 1, further comprising a water separator situated downstream from the at least one fuel cell for separating water from the exhaust gas of the at least one fuel cell.

7. The air supply device according to claim 1, further comprising a control device for controlling the devices of the air supply device.

8. A method for supplying compressed air to at least one fuel cell of an aircraft fuel cell drive, wherein the aircraft fuel cell drive comprises an air supply device having a compressor arrangement, comprising the steps of:
compressing of ambient air by the compressor arrangement;
supplying at least one part of the compressed air to the at least one fuel cell; and
diverting one part of the compressed air for the cooling of the at least one fuel cell depending on the cooling demand of the at least one fuel cell.

9. The method for supplying compressed air to at least one fuel cell of an aircraft fuel cell drive according to claim 8, further comprising the step of:
controlling the compression performance of the compressor arrangement in dependence on the ambient conditions and/or the operating state of the at least one fuel cell.

10. The method for supplying compressed air to at least one fuel cell of an aircraft fuel cell drive according to claim 8, further comprising the step of:
cooling the compressed air.

11. The method for supplying compressed air to at least one fuel cell of an aircraft fuel cell drive according to claim 8, further comprising the step of:
humidifying the compressed air by supplying water.

12. An aircraft fuel cell drive having at least one fuel cell and an air supply device which is configured and arranged according to claim 1.
